(19) United States
(12) Patent Application Publication
(10) Pub. No.: US 2022/0318888 A1
(43) Pub. Date: Oct. 6, 2022

(54) SYSTEM AND METHOD FOR GENERATING AND APPLYING QR CODE FOR PERSISTENT ACCESS TO PRODUCT INFORMATION

(71) Applicant: LifeLabs Design, Inc., Sunnyvale, CA (US)

(72) Inventors: Raymond Scott Mellin, Aspen, CO (US); Vijanderan Somasundaram, Dublin, CA (US)

(21) Appl. No.: 17/590,186

(22) Filed: Feb. 1, 2022

Related U.S. Application Data
(60) Provisional application No. 63/171,275, filed on Apr. 6, 2021.

(51) Int. Cl. G06Q 30/06; G06Q 20/32; G06K 19/06

(52) U.S. Cl. CPC G06Q 30/0641; G06Q 30/0631; G06Q 20/3276; G06K 19/06075; G06K 19/06037

(57) ABSTRACT

A new approach is proposed to support quick response (QR) code generation and application for persistent access to product information. First, a QR code is generated for a commercially available non-perishable product, wherein the QR code includes a set of information of the product including one or more of a unique identification or ID of the product, description of the product, instructions for using the product, and a link to a website describing the product. The generated QR code is then printed or otherwise embedded on a surface of the non-perishable product. When a user who has acquired the product scans the QR code on the product via an electronic scanning device, the electronic scanning device retrieves the set of information of the product from the scanned QR code and presents the set of information of the product to the user for review and/or further actions.

### CROSS-REFERENCE TO RELATED APPLICATIONS

This application claims the benefit of U.S. Provisional Patent Application No. 63/171,275, filed Apr. 6, 2021, which is incorporated herein in its entirety by reference.

### BACKGROUND

Apparel industry has been using physical product labels to describe various information including but not limited to size, material composition (e.g., percentage of cotton or polyester), care instructions (e.g., wash or dry instructions), product origins of clothes and garments commercially available to the consumers. These physical product labels are typically made of cloth or plastic and are sewed to, hanged on to, or otherwise attached to the clothes they describe. As the clothes are worn, washed, and dried over time, the physical product labels may be increasingly worn out with their contents becoming blurred or unrecognizable. In some cases, the physical product labels may even be cut off from their attached clothes by the users if the physical product labels are made of hard materials (e.g., plastic) that may cause discomfort or irritation to the users who wear the clothes. As a result, the product information as covered by the physical product labels is irreversibly lost.

Outside of the apparel industry, other consumer products such as home appliances also often come with product descriptions and/or manuals that cover how the associated products should be set up and used properly as well as other information of the products (e.g., warranty forms and/or a chain of custody from raw materials through to the finished products) in printed paper formats. It is often hard to keep and associate these paper materials together with the products they describe especially after the products have been in use for an extended period of time. Quite often, these paper materials are simply discarded by the users once the products have been set up. Consequently, it may be hard for the users to look for answers from the product manuals or the manufacturer if the products do not perform as expected or certain new features are explored for the first time.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a system diagram to support QR code generation and application for persistent access to product information in accordance with some embodiments.

FIG. 2 depicts a non-limiting example of a QR code created by a QR code generator together with additional logos, slogans, and marks of the manufacturer in accordance with some embodiments.

FIG. 3 depicts a flowchart of an example of a process to support QR code generation and application for persistent access to product information in accordance with some embodiments.

### DETAILED DESCRIPTION OF EMBODIMENTS

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

A new approach is proposed that contemplates systems and methods to support quick response (QR) code generation and application for persistent access to product information. First, a QR code is generated for a commercially available non-perishable product, wherein the QR code includes a set of information of the product including one or more of an unique identification or ID of the product, description of the product, instructions for using the product, and a link to a website describing the product. The generated QR code is then printed on or otherwise embedded in a surface of the non-perishable product. When the product is sold and a user who has purchased/acquired the product scans the QR code on the purchased product via an electronic scanning device, the electronic scanning device retrieves the set of information of the product from the scanned QR code and presents the set of information of the product to the user for review and/or further actions. In some embodiments, the user is directed to a web site about the product for more information. In some embodiments, the manufacturer of the product is notified by the electronic scanning device when the user scans the QR code in order to track and analyze activities of the user of the product. In some embodiments, the manufacturer of the product is configured to authenticate the product based on the product ID and/or other information retrieved from the QR code by the electronic scanning device.

By printing or embedding the QR code on the product, the proposed approach improves sustainability of the product by eliminating the need for physical/hard labels and/or tags made of paper, plastic, or fabrics, which are currently being used for clothes and garments. The proposed approach also enables the user of the product to have sustainable and persistent access to the information about the product without worrying about worn out or missing labels or lost product manuals of the product. Additionally, once scanned, the printed or embedded QR code enables the manufacturer of the product to digitally and remotely track and analyze the product throughout its lifecycle for market study and sales record keeping, and to potentially interact with and/or update the user of the product over a communication network. As such, the proposed approach enables the manufacturer to bring its products digitally to the market via the QR code and to have quicker access to customs and the Federal Trade Commission (FTC). The QR code may also serve as a security label that enables the manufacturer to authenticate the product against potential counterfeits, thus providing a big benefit to both manufacturers and consumers of name-brand products.

As discussed hereinafter, the term “product” refers not only to a piece of clothing, garment, or apparel, but also to any non-perishable consumer product (e.g., any consumer appliance) having a physical/tangible surface that allows a QR code to be printed or otherwise embedded on it.

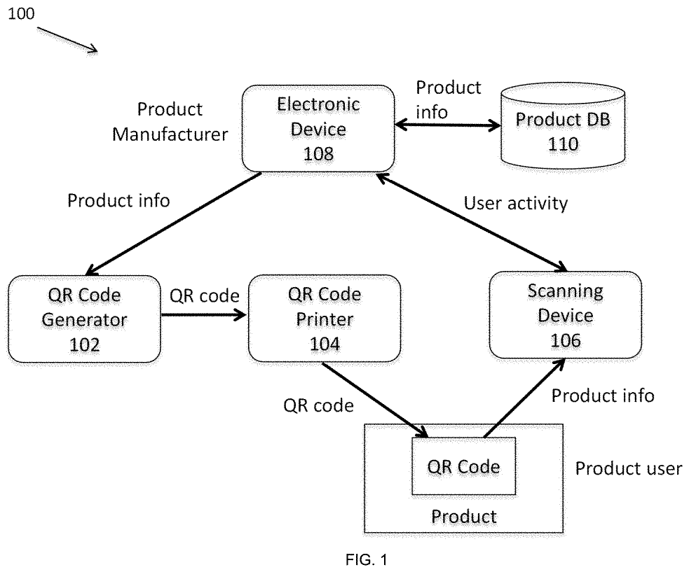

FIG. 1 depicts an example of a system diagram 100 to support QR code generation and application for persistent access to product information. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes at least a code generator 102, a QR code printer 104, a QR code scanning device 106 associated with a user/purchaser of a product, and an electronic device 108 associated with a manufacturer of the product. Each of these components in the system 100 is a unit/appliance/device/host (not shown) having one or more of a processor, a storage unit, and software instructions stored in the storage unit. When the software instructions are executed by the processor, the software instructions enable the hardware unit to practice one or more processes. In some embodiments, each component can be one of a computing device, a communication device, and a storage device. For non-limiting examples, a computing device can be but is not limited to a server machine, a laptop PC, a desktop PC, a tablet, a Google Android device, an iPhone, an iPad, and a voice-controlled speaker or controller. In some embodiments, each component has a communication interface (not shown), which enables the components to communicate with each other, the user, and other devices over one or more communication networks (not shown) following certain communication protocols, such as TCP/IP, http, https, ftp, and sftp protocols. Here, the communication networks can be but are not limited to, Internet, intranet, wide area network (WAN), local area network (LAN), wireless network, Bluetooth, WiFi, and mobile communication network. The physical connections of the network and the communication protocols are well known to those of skilled in the art.

In the example of FIG. 1, the QR code generator 102 is configured to accept a set of information about a product from its manufacturer/supplier/provider. In some embodiments, the set of information is in an electronic form (or format) and can be transmitted via the electronic device 108 associated with the manufacturer over a communication network as described above. Here, the set of information includes one or more of size of the product, origin of the product (e.g., the country where the product is designed, assembled, or made), manufacturing date of the product, material composition of the product, caring instructions of the product, warranty information of the product, a chain of custody information from one or more raw materials through to a finished goods of the product, information of the manufacturer of the product (e.g., address, customer service number, email, social media accounts, etc. of the manufacturer), and a link to a website or a downloadable app of the manufacturer describing the product and/or a user manual of the product (e.g., in PDF format). In some embodiments, the set of information further includes a unique identification or ID of a specific unit/item of the product being sold, wherein such ID uniquely identifies the unit of the product. In some embodiments, the unique ID can be in the form of a barcode that uniquely identifies the product. In some embodiments, the set of information further includes a product tracking code or link that once scanned or clicked by a network-connected device, e.g., a scanning device of the user of the product as discussed below, causes an electronic message (e.g., an email or short message notification) to be sent to the electronic (e.g., computing or communicating) device associated with the manufacturer for product authentication and user activity tracking. In some embodiments, the set of information of the product is maintained in a product database 110 of the manufacturer, which is configured to maintain information and/or user activities throughout the lifecycle of the product for marketing study and sales record keeping.

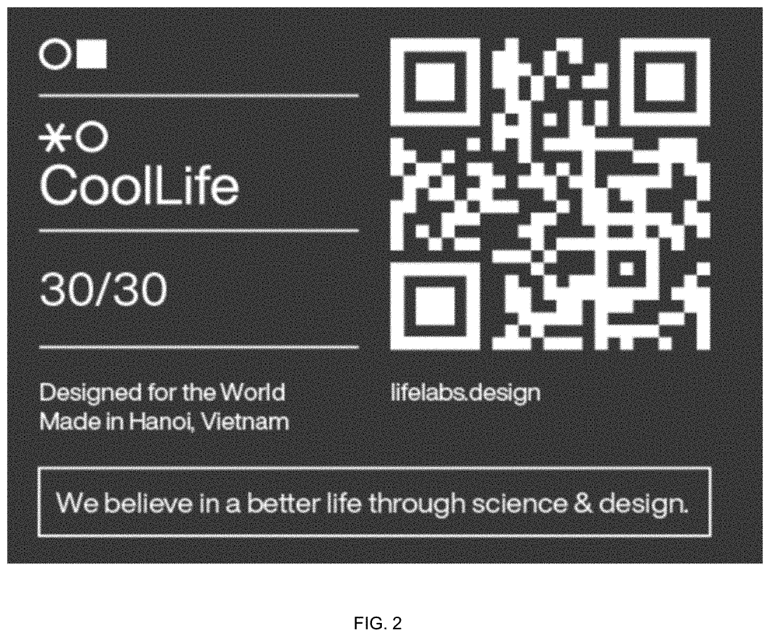

Once the set of information of the product has been accepted, the QR code generator 102 is configured to generate a QR code containing/storing the set of information of the product. Here, the QR code is a type of matrix or two-dimensional barcode, which is a machine-readable label that can contain the set of information about the product. In some embodiments, the QR code includes patterns of black squares arranged in a square grid on a white background, which can be read by a scanning/imaging device such as an image scanner, a camera or camera-included mobile device and processed to have the stored information retrieved. In some embodiments, the QR code generator 102 is configured to encode the set of information of the product via one or more of the following encoding modes numeric, alphanumeric, byte/binary, and kanji to store the set of information in the QR code. Compared to standard UPC barcodes, the QR code provides faster readability and greater storage capacity of the set of information of the product. Note that since the QR code may include the unique ID of a specific unit of the product, in some embodiments, the QR code generated by the QR code generator 102 is unique to the specific unit of the product (vs. being the same for all products of the same style, model or type). FIG. 2 depicts a non-limiting example of a QR code created by the QR code generator 102 together with additional logos, slogans, and marks of the manufacturer (e.g., Lifelabs).

In the example of FIG. 1, the QR code printer 104 is configured to print or otherwise embed the QR code containing the set of information of the product on a physical surface of the product. In the non-limiting example of a clothes or garment, the QR code can be printed at a location near the collar and/or on an inside location of the clothes where conventional clothes labels or tags are attached or sewed to. In the non-limiting example of a home appliance, the QR code can be printed on the bottom or a side surface of the product where product information is usually printed. In some embodiments, the QR code printer 104 is configured to print the QR code in a reliable, permanent, water-resistant, and/or anti-wearing ink so that the QR code is water and tampering resistant and is persistently accessible/readable to the user of the product without any information of the product being lost, altered, or tampered with. With the QR code printed on the product, no other physical label, tag, or material about the product needs to be attached to the product anymore.

In the example of FIG. 1, the QR code scanning device 106 associated with a user who has purchased or otherwise acquired the specific unit of the product is configured to scan the QR code printed or embedded on the product to extract/retrieve the set of information of the product that has been stored in the QR code. Here, the QR code scanning device 106 can be an imaging device or any electronic device equipped with a camera (e.g., a smart mobile phone or tablet). In some embodiments, the QR code scanning device 106 is configured to process the set of information of the product from the scanned QR code using an error correction mechanism (e.g., Reed-Solomon error correction algorithm) until the patterns in the QR code can be interpreted and the set of information can be extracted correctly from the patterns in the QR code.

In some embodiments, the QR code scanning device 106 is configured to present the set of information of the product to the user of the product once such information has been correctly retrieved from the QR code. In some embodiments, the QR code scanning device 106 is configured to automatically direct the user to or enable the user click on a link retrieved from the QR code to be directed to a website or a document about the product the user has purchased. The user may then access all the information about caring and using the product, provide reviews and comments about the product, and repurchase the same or related products again from the manufacturer.

In some embodiments, if the QR code includes a tracking code, the QR code scanning device 106 is configured to recognize, extract, and/or execute the tracking code to automatically send an electronic notification to the electronic device 108 associated with the manufacturer over a communication network once the user has scanned the QR code and successfully retrieved the set of information of the product. Such notification informs the manufacturer that the user/purchaser of the product has started to use the product and enables the manufacturer to track and analyze the user's activity on the website pointed by the link embedded in the QR code throughout its lifecycle of the product via the tracking code for market study and sales record keeping. For a non-limiting example, the electronic device 108 is configured to receive information provided by the scanning device 106 to track how often and when the user accesses the website, from which location the user accesses the website (if a location service such as GPS is enabled on the scanning device 106), how long the user stays on the website, and what other related products the user is interested in. Based on such information, the electronic device 108 is configured to analyze and establish a behavior pattern or profile of the user. The manufacturer may then push additional information to the user via the scanning device 106 wherein such additional information includes but is not limited to answers to any questions and/or comments of the user, additional products that the user may be interested in purchasing, etc. In some embodiments, the electronic device 108 is configured to retrieve the unique product ID and/or other information of the specific unit of the product purchased by the user in order to authenticate/verify or ascertain the authenticity of the product. In some embodiments, the QR code may serve as a security label wherein the electronic device 108 is configured to look up the received product ID from the product database 110, which maintains identifications and records of authentic products by the manufacturer. In some embodiments, the product database 110 further maintains a chain of custody information from one or more raw materials through to the finished goods for each of the products. If the product ID is found in the product database 110, the electronic device 108 is configured to mark the product as authentic. If the product ID is not found or marked as fake in the product database, the electronic device 108 is configured to identify the product as a counterfeit and notify the user accordingly by sending a notification to the scanning device 106 associated with the user.

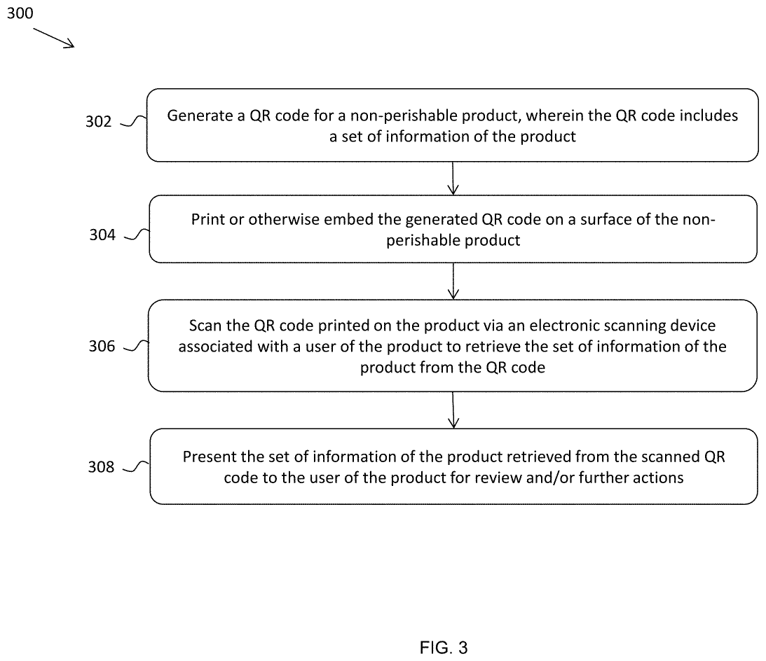

FIG. 3 depicts a flowchart 300 of an example of a process to support QR code generation and application for persistent access to product information. Although the figure depicts functional steps in a particular order for purposes of illustration, the processes are not limited to any particular order or arrangement of steps. One skilled in the relevant art will appreciate that the various steps portrayed in this figure could be omitted, rearranged, combined and/or adapted in various ways.

In the example of FIG. 3, the flowchart 300 starts at block 302, where a QR code is generated for a non-perishable product, wherein the QR code includes a set of information of the product. The flowchart 300 continues to block 304, where the generated QR code is printed or otherwise embedded on a surface of the non-perishable product. The flowchart 300 continues to block 306, where the QR code printed on the product is scanned via an electronic scanning device associated with a user of the product and the set of information of the product is retrieved from the QR code. The flowchart 300 ends at block 308, where the set of information of the product retrieved from the scanned QR code is presented to the user of the product for review and/or further actions.

The foregoing description of various embodiments of the claimed subject matter has been provided for the purposes of illustration and description. It is not intended to be exhaustive or to limit the claimed subject matter to the precise forms disclosed. Many modifications and variations will be apparent to a practitioner skilled in the art. Embodiments were chosen and described in order to best describe the principles of the invention and its practical application, thereby enabling others skilled in the relevant art to understand the claimed subject matter, the various embodiments and the various modifications that are suited to the particular use contemplated.

What is claimed is:

1. A system, comprising:
a quick response (QR) code generator configured to
accept a set of information of a product in an electronic form over a communication network;
generate a QR code containing the set of information of the product by encoding the set of information of the product in the QR code via one or more of numeric, alphanumeric, byte/binary, and kanji encoding modes, wherein the QR code is a label readable by a QR code scanning device to have the set of information of the product retrieved;
a QR code printer configured to print or embed the QR code containing the set of information of the product on a physical surface of the product;
a product database configured to maintain the set of information of the product and/or activities of a user who acquires the product throughout lifecycle of the product.

2. The system of claim 1, further comprising:
said QR code scanning device associated with the user who acquires the product and configured to
scan the QR code printed or embedded on the product to extract/retrieve the set of information of the product that has been stored in the QR code;
present the set of information of the product to the user of the product once such information has been correctly retrieved from the QR code.

3. The system of claim 1, wherein:
the set of information of the product includes one or more of size of the product, origin of the product, manufacturing date of the product, material composition of the product, caring instructions of the product, warranty information of the product, a chain of custody information from one or more raw materials through to a finished goods of the product, information of a manufacturer of the product, and a link to a web site or a downloadable app of the manufacturer describing the product and/or a user manual of the product.

4. The system of claim 1, wherein:
the set of information of the product includes a unique identification or ID of a specific unit/item of the product being sold, wherein such ID uniquely identifies the unit of the product.

5. The system of claim 1, wherein:
the QR code is a matrix or two-dimensional barcode that includes patterns of black squares arranged in a square grid on a white background.

6. The system of claim 1, wherein:
the QR code printer is configured to print the QR code in a permanent, water-resistant, and/or anti-wearing ink so that the QR code is water and tampering resistant and is persistently accessible/readable to a user of the product without any information of the product being lost, altered, or tampered with.

7. The system of claim 2, wherein:
the QR code scanning device is an imaging device or an electronic device equipped with a camera that is utilized for scanning purposes.

8. The system of claim 2, wherein:
the QR code scanning device is configured to process the set of information of the product from the scanned QR code using an error correction mechanism until the set of information is extracted correctly from the QR code.

9. The system of claim 2, wherein:
the QR code scanning device is configured to automatically direct the user to a website or a document about the product the user has acquired.

10. The system of claim 2, wherein:
the set of information of the product includes a product tracking code.

11. The system of claim 10, wherein:
the QR code scanning device is configured to
recognize and extract the product tracking code in the set of information of the product;
automatically send an electronic notification to an electronic device associated with a provider of the product over a communication network for product authentication and user activity tracking.

12. The system of claim 11, further comprising:
said electronic device associated with the provider of the product and configured to track and analyze one or more activities of the user with respect to the product throughout the lifecycle of the product via the product tracking code.

13. The system of claim 12, wherein:
the electronic device is configured to analyze and establish a behavior pattern or profile of the user.

14. The system of claim 12, wherein:
the electronic device is configured to retrieve a unique product ID and/or other information of the product in order to verify authenticity of the product using the QR code as a security label.

15. The system of claim 1, wherein:
the product database is configured to further maintain a chain of custody information from one or more raw materials through to a finished goods of the product.

16. A method, comprising:
accepting a set of information of a product in an electronic form over a communication network;
generating a QR code containing the set of information of the product by encoding the set of information of the product in the QR code via one or more of numeric, alphanumeric, byte/binary, and kanji encoding modes, wherein the QR code is a label readable by a QR code scanning device to have the set of information of the product retrieved;
printing or embedding the QR code containing the set of information of the product on a physical surface of the product;
maintaining in a product database the set of information of the product and/or activities of a user who acquires the product throughout lifecycle of the product.

17. The method of claim 16, further comprising:
printing the QR code in a permanent, water-resistant, and/or anti-wearing ink so that the QR code is water and tampering resistant and is persistently accessible/readable to a user of the product without any information of the product being lost, altered, or tampered with.

18. The method of claim 16, further comprising:
scanning the QR code printed or embedded on the product via said QR code scanning device associated with the user who acquires the product to extract/retrieve the set of information of the product that has been stored in the QR code;
presenting the set of information of the product to the user of the product once such information has been correctly retrieved from the QR code.

19. The method of claim 18, further comprising:
processing the set of information of the product from the scanned QR code using an error correction mechanism until the set of information is extracted correctly from the QR code.

20. The method of claim 18, further comprising:
automatically directing the user to a web site or a document about the product the user has acquired.

21. The method of claim 18, further comprising:
recognizing and extracting a product tracking code in the set of information of the product;
automatically sending an electronic notification to an electronic device associated with a provider of the product over a communication network for product authentication and user activity tracking.

22. The method of claim 21, further comprising:
tracking and analyzing by said electronic device associated with the provider of the product one or more activities of the user with respect to the product throughout the lifecycle of the product via the product tracking code.

23. The method of claim 22, further comprising:
analyzing and establishing a behavior pattern or profile of the user.

24. The method of claim 22, further comprising:
retrieving a unique product ID and/or other information of the product in order to verify authenticity of the product using the QR code as a security label.

25. The method of claim 16, further comprising:
maintaining a chain of custody information from one or more raw materials through to a finished goods of the product.

26. A system, comprising:
a means for accepting a set of information of a product in an electronic form over a communication network;
a means for generating a QR code containing the set of information of the product by encoding the set of information of the product in the QR code via one or more of numeric, alphanumeric, byte/binary, and kanji encoding modes, wherein the QR code is a label readable by a QR code scanning device to have the set of information of the product retrieved;
a means for printing or embedding the QR code containing the set of information of the product on a physical surface of the product;
a means for maintaining in a product database the set of information of the product and/or activities of a user who acquires the product throughout lifecycle of the product.
